(19) United States
(12) Patent Application Publication
(10) Pub. No.: US 2022/0413485 A1
(43) Pub. Date: Dec. 29, 2022

(54) CARWASH DEVICE, CAR-WASHING METHOD, STORAGE MEDIUM STORED WITH CAR-WASHING PROGRAM, AND CAR-WASHING SYSTEM

(71) Applicant: TOYOTA JIDOSHA KABUSHIKI KAISHA, Aichi-ken (JP)

(72) Inventors: Teruaki HAIBARA, Kanagawa-ken (JP); Kenji HOSHI, Gotemba-shi (JP); Masaaki SATO, Susono-shi (JP)

(21) Appl. No.: 17/808,539

(22) Filed: Jun. 24, 2022

(30) Foreign Application Priority Data
Jun. 28, 2021 (JP) 2021-107107

(51) Int. Cl. G05D 1/00; G07C 5/00; G07C 5/08; B60S 3/04

(52) U.S. Cl. CPC G05D 1/0011; G07C 5/008; G07C 5/0833; G07C 5/0825; B60S 3/04

(57) ABSTRACT

A carwash device receives vehicle state information transmitted from a vehicle control device of a vehicle. The carwash device controls so as to drive a drive section for washing the vehicle based on the received vehicle state information.

### CROSS-REFERENCE TO RELATED APPLICATION

This application is based on and claims priority under 35 USC 119 from Japanese Patent Application No. 2021-107107 filed on Jun. 28, 2021, the disclosure of which is incorporated by reference herein.

### BACKGROUND

### Technical Field

The present disclosure relates to a carwash device, a car-washing method, a storage medium stored with a car-washing program, and a car-washing system.

### Related Art

Hitherto, carwash devices, car-washing methods, and car-washing programs have been proposed to enable a vehicle to be washed at an appropriate timing (such as Japanese Patent Application Laid-Open (JP-A) No. 2020-179709). The carwash device in JP-A No. 2020-179709 computes the next car-washing timing of a vehicle based on historical data including a car-washing history of the vehicle, informs a terminal linked to the vehicle of the next car-washing timing, estimates a dirtiness level of the vehicle based on an image of the vehicle input from a carwash unit, selects a car-washing menu according to the dirtiness level, and controls the carwash unit such that vehicle is washed based on the selected car-washing menu. Note that JP-A No. 2020-179709 also describes that a determination as to whether any vehicle window has been left open is made based on a vehicle image input from the carwash unit. In cases in which a determination is made that a window has been left open, the vehicle is controlled such that this open window is closed (for example, claim 4).

The technology disclosed in JP-A No. 2020-179709 determines whether any vehicle window has been left open based on the vehicle image, and in cases in which a determination is made that a window has been left open, controls the vehicle such that this open window is closed.

However, in cases in which determination processing is executed based on an image as in JP-A No. 2020-179709, the image recognition processing may sometimes be inaccurate. In such cases, car-washing might be executed in a state in which a vehicle window is still open.

In consideration of the above circumstances, an object of the present disclosure is to execute car-washing in an appropriate manner according to vehicle state information provided from a vehicle.

### SUMMARY

In order to achieve the above object, a first aspect of the present disclosure is a carwash device including a reception section configured to receive vehicle state information transmitted from a vehicle control device of a vehicle, and a control section configured to control so as to drive a drive section for washing the vehicle based on the vehicle state information received by the reception section.

The carwash device of the first aspect of the present disclosure receives the vehicle state information transmitted from the vehicle control device of the vehicle. The carwash device controls so as to drive the drive section for washing the vehicle based on the received vehicle state information. This enables car-washing to be executed in an appropriate manner according to the vehicle state information provided from the vehicle. Specifically, there is no need to determine a state of the vehicle by image processing, thereby enabling reliable vehicle state information to be acquired, and enabling car-washing of the vehicle to be executed in an appropriate manner according to this information.

In a carwash device of a second aspect of the present disclosure, the vehicle state information includes at least one type of information selected from the group consisting of a deployed/retracted state of a door mirror, an open/closed state of a window, an open/closed state of a door, an open/closed state of a fuel filler port, and an ignition state indicating a state of an ignition. The control section controls the drive section so as to wash the vehicle in a case in which the vehicle state information satisfies a predetermined condition. The second aspect of the present disclosure enables car-washing to be executed in cases in which the at least one type of vehicle state information selected from the group consisting of the deployed/retracted state of the door mirror, the open/closed state of the window, the open/closed state of the door, the open/closed state of the fuel filler port, and the ignition state has satisfied the predetermined condition.

In a carwash device of a third aspect of the present disclosure, the control section is configured to output a request signal to the vehicle control device requesting to start car-washing of the vehicle. The vehicle control device is configured to output the vehicle state information to the carwash device in response to the request signal. The control section outputs an instruction signal to the vehicle control device instructing to change a state of a specific component included in the vehicle in a case in which the vehicle state information does not satisfy a predetermined condition. The vehicle control device is configured to either control so as to change the state of the specific component included in the vehicle in response to the instruction signal, control so as to display information indicating that the vehicle state information does not satisfy the predetermined condition on a display section inside the vehicle, or control so as to output a warning sound indicating that the vehicle state information does not satisfy the predetermined condition through an audio output device inside the vehicle. The third aspect of the present disclosure enables car-washing to be executed after the state of the specific component included in the vehicle has been set to a suitable state for car-washing. The third aspect of the present disclosure also enables a user, this being an occupant of the vehicle, to be notified of the fact that the vehicle is in an unsuitable state for car-washing.

In a carwash device of a fourth aspect of the present disclosure, the control section is configured to output a request signal to the vehicle control device requesting to start car-washing of the vehicle. The vehicle control device is configured to control so as to change a state of specific component included in the vehicle in response to the received request signal. The fourth aspect of the present disclosure enables car-washing to be executed after the state of the specific component included in the vehicle has been set to a suitable state for car-washing.

A carwash device of a fifth aspect of the present disclosure further includes a car-washing mode selection section configured to select a car-washing mode based on the vehicle state information. The control section is configured to control the drive section so as to wash the vehicle in the car-washing mode selected by the car-washing mode selection section. The fifth aspect of the present disclosure enables the car-washing mode to be changed based on the vehicle state information (such as whether a door mirror is retracted).

A carwash device of a sixth aspect of the present disclosure further includes a car-washing mode selection section. The reception section is configured to additionally receive vehicle type information indicating a type of the vehicle. The car-washing mode selection section is configured to select a car-washing mode based on the vehicle state information and the vehicle type information. The control section is configured to control so as to drive the drive section according to the selected car-washing mode. The sixth aspect of the present disclosure enables the car-washing mode to be changed based on the vehicle type.

A carwash device of a seventh aspect of the present disclosure further includes a car-washing mode selection section. The reception section is configured to additionally receive travel history information indicating a travel history of the vehicle. The car-washing mode selection section is configured to select a car-washing mode based on the vehicle state information and the travel history information. The control section is configured to control so as to drive the drive section according to the selected car-washing mode. The seventh aspect of the present disclosure enables the car-washing mode to be changed based on the travel history information of the vehicle.

An eighth aspect of the present disclosure is a car-washing system including the carwash device of any one of the first aspect to the seventh aspect, and a vehicle control device. Similarly to the first aspect, the eighth aspect of the present disclosure enables car-washing to be executed in an appropriate manner according the vehicle state information provided from the vehicle.

A ninth aspect of the present disclosure is a car-washing method in which a computer executes processing including receiving vehicle state information transmitted from a vehicle control device of a vehicle, and controlling so as to drive a drive section for washing the vehicle based on the received vehicle state information. Similarly to the first aspect, the ninth aspect of the present disclosure enables car-washing to be executed in an appropriate manner according the vehicle state information provided from the vehicle.

A tenth aspect of the present disclosure is a storage medium stored with a car-washing program for causing a computer to execute processing including receiving vehicle state information transmitted from a vehicle control device of a vehicle, and controlling so as to drive a drive section for washing the vehicle based on the received vehicle state information. Similarly to the first aspect, the tenth aspect of the present disclosure enables car-washing to be executed in an appropriate manner according the vehicle state information provided from the vehicle.

As described above, the present disclosure obtains an advantageous effect of enabling car-washing to be executed in an appropriate manner according the vehicle state information provided from the vehicle.

### BRIEF DESCRIPTION OF DRAWINGS

FIG. 1 is a diagram illustrating an example of a schematic configuration of a car-washing system according to an exemplary embodiment;

FIG. 2 is a block diagram illustrating an example of functional configuration of a car-washing system according to a first exemplary embodiment;

FIG. 3 is a diagram illustrating an example of a configuration of a computer that implements respective devices according to an exemplary embodiment;

FIG. 4 is a flowchart illustrating an example of a flow of processing performed by a carwash device according to the first exemplary embodiment;

FIG. 5 is a diagram for explaining car-washing conditions, these being an example of predetermined conditions:

FIG. 6 is a flowchart illustrating an example of a flow of processing performed by a vehicle control device according to the first exemplary embodiment:

FIG. 7 is a block diagram illustrating an example of functional configuration of a car-washing system according to a second exemplary embodiment;

FIG. 8 is a flowchart illustrating an example of a flow of processing performed by a carwash device according to the second exemplary embodiment;

FIG. 9 is a diagram for explaining car-washing modes according to vehicle state information; and

FIG. 10 is a diagram illustrating an example of a schematic configuration of a modified example of a car-washing system according to an exemplary embodiment.

### DESCRIPTION OF EMBODIMENTS

Detailed explanation follows regarding exemplary embodiments of the present disclosure, with reference to the drawings.

### First Exemplary Embodiment

Vehicle Control System

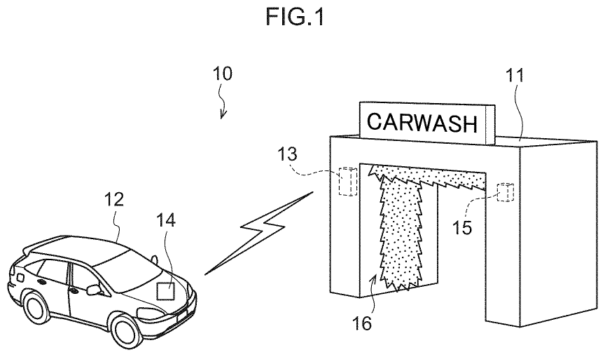

FIG. 1 is a diagram for explaining an overview of a car-washing system 10 according to a first exemplary embodiment. As illustrated in FIG. 1, the car-washing system 10 of the first exemplary embodiment includes a carwash unit 11 and a vehicle 12. The carwash unit 11 includes a carwash device 13, a drive section 15, and brushes 16. A vehicle control device 14 is installed to the vehicle 12. Note that the vehicle control device 14 is for example an electronic control unit (ECU). The carwash device 13 and the vehicle control device 14 are connected so as to be capable of communicating with each other.

When the vehicle 12 is to be washed, any door mirrors of the vehicle 12 are preferably set to a retracted state. This is because the door mirrors might be damaged during certain modes of car-washing in cases in which car-washing is performed while a door mirror is in a deployed state.

Moreover, when the vehicle 12 is to be washed, any doors and windows of the vehicle 12 are also preferably set to a closed state. This is because water might enter the vehicle 12 during certain modes of car-washing in cases in which car-washing is performed while a door is in an open state.

The carwash device 13 of the car-washing system 10 of the present exemplary embodiment acquires vehicle state information indicating states of the vehicle 12 from the vehicle control device 14, and executes car-washing of the vehicle 12 according to the vehicle state information. Specifically, car-washing of the vehicle 12 is executed in cases in which the vehicle state information satisfies predetermined conditions (such as in cases in which the vehicle state information indicates that the door mirrors are in the retracted state).

This enables the carwash device 13 to execute car-washing in an appropriate manner according to the vehicle state information provided from the vehicle 12.

Detailed explanation follows below.

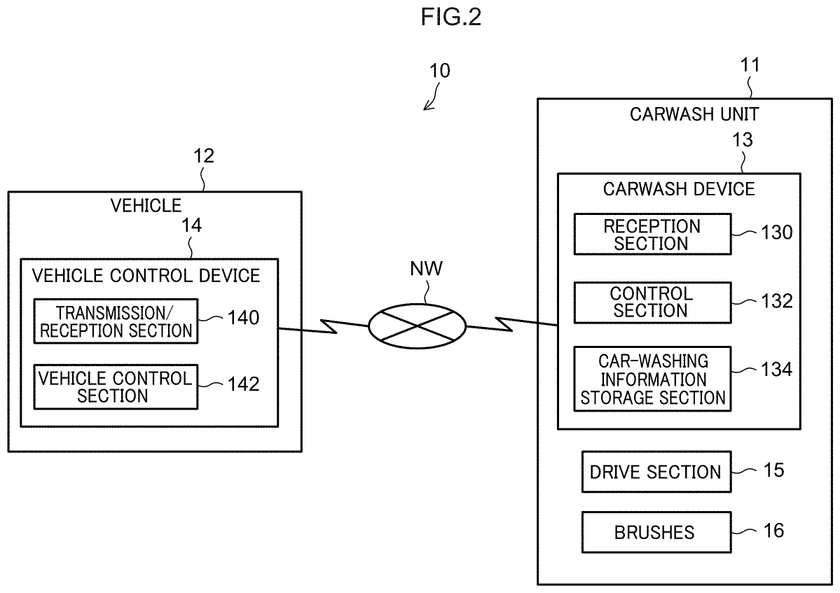

FIG. 2 is a block diagram illustrating an example of functional configuration of the car-washing system 10 according to the first exemplary embodiment. As illustrated in FIG. 2, the car-washing system 10 includes the vehicle 12 and the carwash unit 11. The vehicle control device 14 included in the vehicle 12 includes a transmission/reception section 140 and a vehicle control section 142. The carwash unit 11 includes the carwash device 13, the drive section 15, and the brushes 16. The carwash device 13 included in the carwash unit 11 includes a reception section 130, a control section 132, and a car-washing information storage section 134. The vehicle control device 14 and the carwash device 13 are connected so as to be capable of communicating with each other over a predetermined communication network NW.

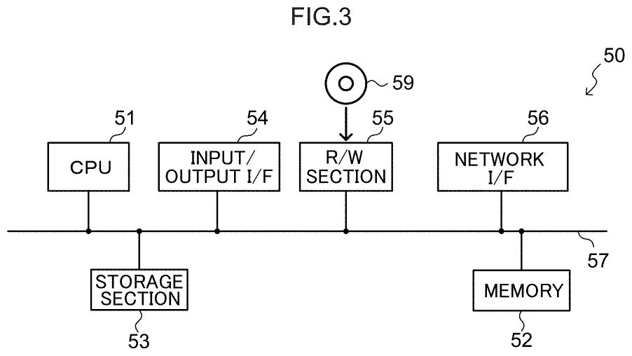

The vehicle control device 14 and the carwash device 13 may for example be implemented by computer 50 such as that illustrated in FIG. 3. The computer 50 that implements the vehicle control device 14 and the carwash device 13 includes a central processing unit (CPU) 51, memory 52 serving as a temporary storage region, and a non-volatile storage section 53. The computer 50 also includes an input/output interface (I/F) 54 to which an input/output device and so on (not illustrated in the drawings) are connected, and a read/write (R/W) section 55 that controls reading and writing of data with respect to a recording medium 59. The computer 50 also includes a network I/F 56 that is connected to a network such as the internet. The CPU 51, the memory 52, the storage section 53, the input/output I/F 54, the R/W section 55, and the network I/F 56 are connected to each other through a bus 57.

The storage section 53 may be implemented by a hard disk drive (HDD), a solid state drive (SSD), flash memory, or the like. The storage section 53 serves as a storage medium that stores a program for causing the computer 50 to function. The CPU 51 reads the program from the storage section 53 and expands the program in the memory 52 to sequentially execute processes included in the program.

Next, explanation follows regarding operation of the car-washing system 10 of the first exemplary embodiment.

For example, the vehicle control device 14 initiates a car-washing mode in cases in which a distance between the vehicle 12 and the carwash unit 11 is a predetermined distance or less, and signals successively output by the carwash device 13 are received by the vehicle control device 14.

In such cases, the control section 132 of the carwash device 13 outputs a request signal to the vehicle control device 14 requesting to start car-washing of the vehicle 12.

The transmission/reception section 140 of the vehicle control device 14 receives the request signal transmitted from the carwash device 13. The vehicle control section 142 of the vehicle control device 14 transmits vehicle state information indicating states of the vehicle 12 to the carwash device 13 in response to the request signal. The vehicle state information is information indicating states of specific components of the vehicle 12. The vehicle state information includes at least one type of information selected from the group consisting of a door mirror deployed/retracted state, a window open/closed state, a door open/closed state, a fuel filler port open/closed state, and an ignition state indicating a state of the ignition. The information indicating the ignition state is information indicating whether or not the ignition is on or off.

For example, the vehicle control device 14 acquires the information indicating whether the door mirrors are in a deployed state or a retracted state from a predetermined sensor or from an ECU for driving the door mirrors included in the vehicle 12. The vehicle control device 14 similarly acquires the window open/closed state, door open/closed state, fuel filler port open/closed state, and ignition state of the vehicle 12 from predetermined sensors or other ECUs. The vehicle control device 14 then transmits the vehicle state information including this information to the carwash device 13.

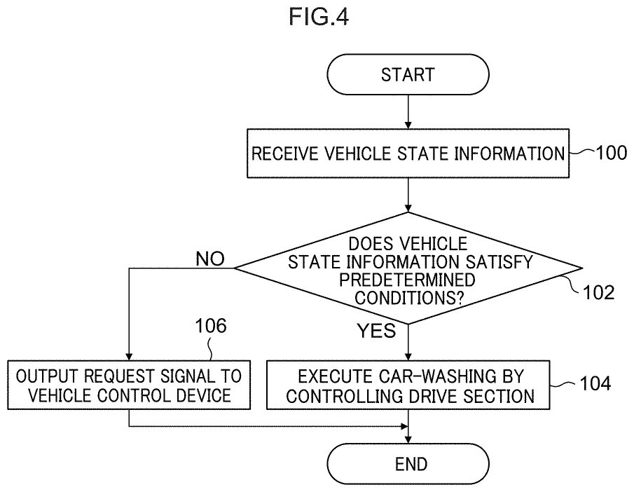

When the vehicle state information is transmitted from the vehicle control device 14 to the carwash device 13, the carwash device 13 executes the flowchart illustrated in FIG. 4. The flowchart in FIG. 4 is executed each time vehicle state information is transmitted from the vehicle control device 14 to the carwash device 13.

At step S100, the reception section 130 of the carwash device 13 receives the vehicle state information transmitted from the vehicle control device 14. The control section 132 of the carwash device 13 controls so as to drive the drive section 15 for washing the vehicle 12 based on the vehicle state information.

At step S102, the control section 132 of the carwash device 13 determines whether or not the vehicle state information received at step S100 satisfies predetermined conditions.

Specifically, first, the control section 132 reads information relating to car-washing conditions, these being the predetermined conditions, held in the car-washing information storage section 134.

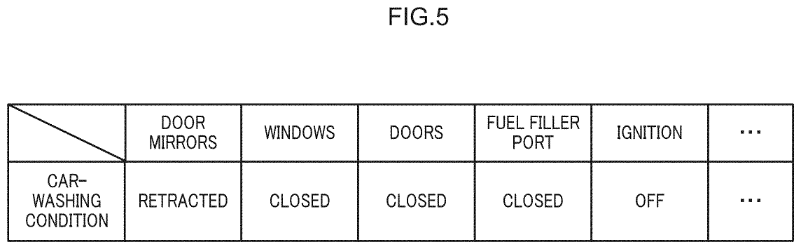

FIG. 5 illustrates an example of the car-washing conditions held in the car-washing information storage section 134. As illustrated in FIG. 5, the car-washing conditions in the car-washing information storage section 134 stipulate that the door mirrors are “retracted”, the windows are “closed”, the doors are “closed”, the fuel filler port is “closed”, and the ignition is “off”. In the processing described below, car-washing of the vehicle 12 is executed in cases in which the vehicle 12 satisfies these car-washing conditions.

Thus, at step S102, the control section 132 references the car-washing conditions held in the car-washing information storage section 134, and in cases in which the vehicle state information indicates that a door is “open”, the control section 132 determines that the vehicle state information does not satisfy the car-washing conditions. In such cases, the processing transitions to step S106.

On the other hand, in cases in which the control section 132 references the car-washing conditions at step S102 and the vehicle state information indicates that the door mirrors are “retracted”, the windows are “closed”, the doors are “closed”, the fuel filler port is “closed”, and the ignition state is “off”, the control section 132 determines that the vehicle state information satisfies the car-washing conditions. In such cases, the processing transitions to step S104.

At step S104, the control section 132 of the carwash device 13 controls so as to drive the drive section 15 for washing the vehicle 12 so as to execute car-washing of the vehicle 12. Note that when this is performed, communication processing is performed between the carwash device 13 and the vehicle control device 14 such that the vehicle 12 enters the carwash unit 11. The brushes 16 are then actuated by driving the drive section 15 under the control of the control section 132 of the carwash device 13, and car-washing of the vehicle 12 is performed.

At step S106, the control section 132 of the carwash device 13 outputs an instruction signal to the vehicle control device 14 instructing a change in the states of the specific components included in the vehicle 12.

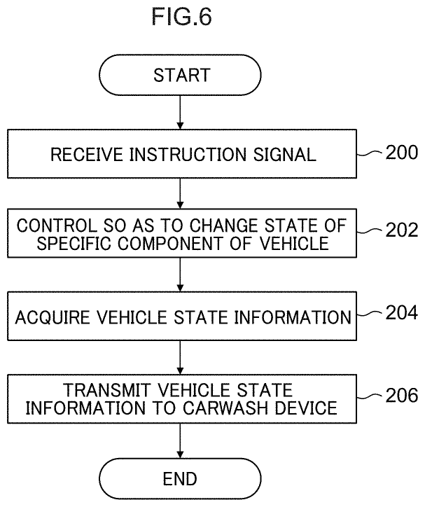

When this instruction signal is output from the carwash device 13 to the vehicle control device 14, the vehicle control device 14 executes the flowchart illustrated in FIG. 6.

At step S200, the transmission/reception section 140 of the vehicle control device 14 receives the instruction signal transmitted from the carwash device 13.

At step S202, the vehicle control section 142 of the vehicle control device 14 controls so as to change the states of the specific components included in the vehicle 12 in response to the instruction signal received at step S200. For example, in cases in which the instruction signal transmitted from the carwash device 13 instructs to retract the door mirrors, the vehicle control section 142 outputs a control signal to the ECU that drives the door mirrors so as to retract the door mirrors. Alternatively, for example, in cases in which the instruction signal transmitted from the carwash device 13 instructs to close the doors, the vehicle control section 142 outputs a control signal to the ECU that drives the doors so as to close the doors. The states of the specific components included in the vehicle 12 are changed in this manner, such that the specific components of the vehicle 12 are set to suitable states for car-washing.

At step S204, the vehicle control section 142 of the vehicle control device 14 acquires vehicle state information indicating the states of the specific components from the sensors or ECUs included in the vehicle 12.

At step S206, the vehicle control section 142 of the vehicle control device 14 transmits the vehicle state information acquired at step S204 to the carwash device 13.

When the vehicle state information is transmitted from the vehicle control device 14 to the carwash device 13, the carwash device 13 again executes the flowchart illustrated in FIG. 4. Car-washing of the vehicle 12 is then executed in cases in which the vehicle state information satisfies the predetermined conditions.

As described above, the carwash device of the car-washing system according to the present exemplary embodiment receives the vehicle state information transmitted from the vehicle control device of the vehicle, and controls so as to drive the drive section for washing the vehicle based on the received vehicle state information. This enables car-washing to be executed in an appropriate manner according to the vehicle state information provided from the vehicle. Specifically, the vehicle can be washed automatically without having to perform determination processing by image processing or the like. Thus for example, a situation can be suppressed from arising in which car-washing is executed despite a vehicle door actually being open due to image processing being inaccurate, such that water enters the vehicle 12.

### Second Exemplary Embodiment

Next, explanation follows regarding a second exemplary embodiment. Note that sections of the car-washing system according to the second exemplary embodiment that are similar to those in the first exemplary embodiment are allocated the same reference numerals, and explanation thereof is omitted. The carwash device of the car-washing system of the second exemplary embodiment differs from the first exemplary embodiment in the respect that a car-washing mode of the vehicle 12 is selected based on the vehicle state information.

In the first exemplary embodiment, an example was given in which car-washing is executed in cases in which the vehicle state information satisfies predetermined conditions. However, there are situations in which the vehicle 12 can be washed in an appropriate manner by changing the car-washing mode, even in cases in which the vehicle state information does not satisfy the predetermined conditions.

For example, even in cases in which the door mirrors are not in the retracted state, the vehicle 12 may be able to be washed without damaging the door mirrors by adjusting the manner in which the brushes 16 contact the door mirrors.

In the car-washing system of the second exemplary embodiment, a car-washing mode of the vehicle 12 is selected according the vehicle state information, and the drive section 15 is controlled so as to wash the vehicle 12 in the selected car-washing mode. This enables car-washing to be executed in an appropriate manner, even in cases in which a component of the vehicle is not in a suitable state for car-washing.

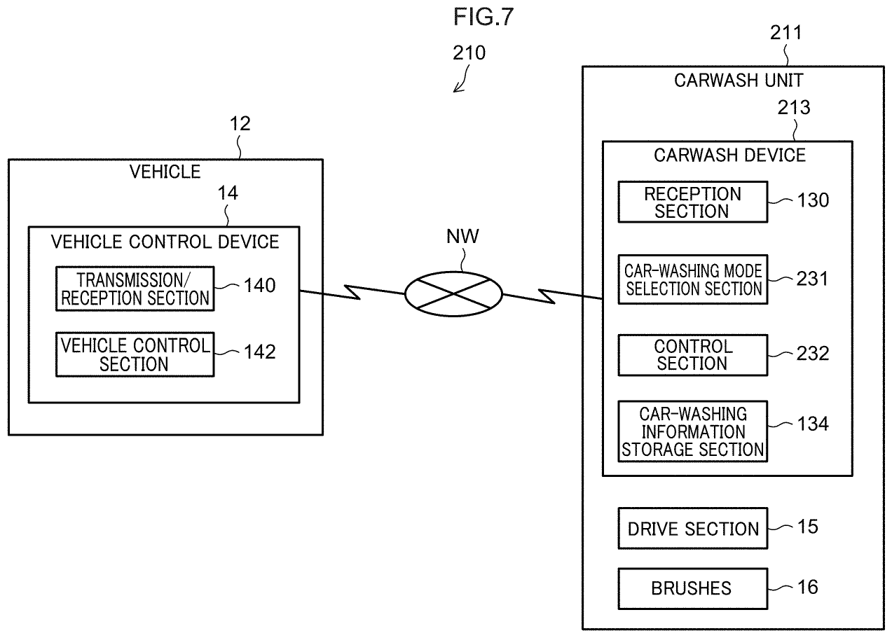

FIG. 7 is a block diagram illustrating an example of functional configuration of a car-washing system 210 according to the second exemplary embodiment. As illustrated in FIG. 7, a carwash device 213 of the car-washing system 210 additionally includes a car-washing mode selection section 231.

The car-washing mode selection section 231 of the carwash device 213 selects a car-washing mode of the vehicle 12 based on the vehicle state information.

A control section 232 of the carwash device 213 controls the drive section 15 such that the vehicle 12 is washed in the car-washing mode selected by the car-washing mode selection section 231.

Next, explanation follows regarding operation of the car-washing system 210 of the second exemplary embodiment.

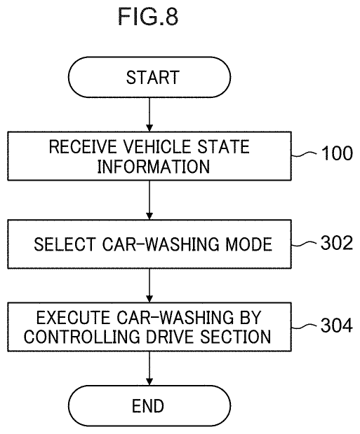

When the vehicle state information is transmitted from the vehicle control device 14 to the carwash device 213, the carwash device 213 executes the flowchart illustrated in FIG. 8.

At step S100, the reception section 130 of the carwash device 13 receives the vehicle state information transmitted from the vehicle control device 14.

At step S302, the car-washing mode selection section 231 of the carwash device 13 selects a car-washing mode based on the vehicle state information received at step S100.

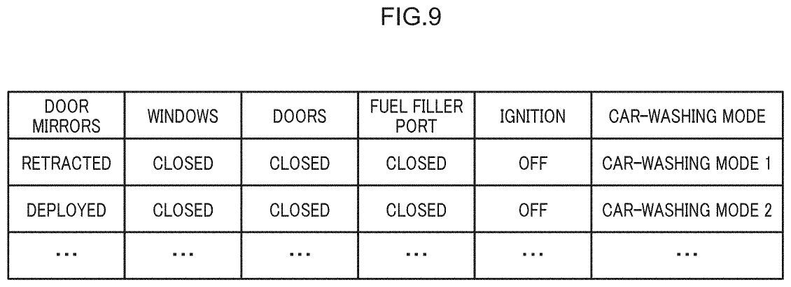

Note that information such as that illustrated in FIG. 9 is held in the car-washing information storage section 134 of the carwash device 13 of the second exemplary embodiment.

Thus, at step S302, the car-washing mode selection section 231 references the information held in the car-washing information storage section 134 in order to select a car-washing mode according to the vehicle state information.

For example, as illustrated in FIG. 9, in cases in which the door mirrors are in the “retracted” state, the windows, doors, and fuel filler port are in the “closed” states, and the ignition is in the “off” state, the car-washing mode selection section 231 selects a car-washing mode 1 as the car-washing mode of the vehicle 12. On the other hand, as illustrated in FIG. 9, in cases in which the door mirrors are in the “deployed” state, whereas the windows, doors, and fuel filler port are in the “closed” states and the ignition is in the “off” state, the car-washing mode selection section 231 selects a car-washing mode 2 as the car-washing mode of the vehicle 12. Note that the car-washing mode 2 is for example a car-washing mode in which the manner in which the brushes 16 contact the door mirrors differs from the car-washing mode 1, such that the door mirrors are not damaged even in the “deployed” state.

At step S304, the control section 132 of the carwash device 13 controls so as to drive the drive section 15 for washing the vehicle 12 such that the vehicle 12 is washed in the car-washing mode selected at step S302.

As described above, the carwash device of the car-washing system according to the second exemplary embodiment receives the vehicle state information transmitted from the vehicle control device of the vehicle, and controls so as to drive the drive section for washing the vehicle based on the received vehicle state information. This enables car-washing to be executed in an appropriate manner according to the vehicle state information provided from the vehicle. Specifically, since the vehicle can be washed according to the states of the specific components included in the vehicle, a situation in which for example a component included in the vehicle is damaged can be suppressed from arising.

The present disclosure is not limited to the above embodiments, and obviously various other modifications may be implemented within a range not departing from the spirit of the present disclosure.

For example, although an example has been described in the above exemplary embodiments in which the vehicle 12 is washed based on the vehicle state information transmitted from the vehicle control device 14, there is no limitation thereto. For example, the carwash device 13 may further acquire vehicle type information indicating a type of the vehicle 12, and select a car-washing mode based on the vehicle type information and the vehicle state information. In such cases, the vehicle type information may be information indicating whether the vehicle 12 that is the car-washing target is a taxi, a privately owned vehicle, a shared vehicle, a hybrid vehicle (HV), or an electric vehicle (EV). For example, in cases in which the car-washing target vehicle 12 is a taxi, a sign or indicator lamp may be present on the roof of the vehicle, and so it may be preferable to wash the vehicle in a car-washing mode that avoids this area. Thus, selecting a car-washing mode based on the vehicle type information and the vehicle state information enables car-washing to be executed in an appropriate manner according to the vehicle type.

Alternatively, for example, the carwash device 13 may additionally acquire travel history information indicating a travel history of the vehicle 12, and select a car-washing mode based on the travel history information and the vehicle state information. In such cases, the travel history information is information including information regarding routes that the car-washing target vehicle 12 has actually traveled, and weather information and so on during this travel. For example, the travel history information may include information indicating that the car-washing target vehicle 12 has traveled along seaside roads, information indicating that the car-washing target vehicle 12 has traveled along snowy roads, information indicating the season of travel, and information indicating the weather during travel. For example, in cases in which the car-washing target vehicle 12 frequently travels along seaside roads, dirt containing salt might have adhered to the vehicle 12, and so a car-washing mode may be selected in which the vehicle 12 is washed using a different detergent to the normal car-washing detergent. Thus, selecting a car-washing mode based on the travel history information and the vehicle state information enables car-washing to be executed in an appropriate manner according to the travel history of the vehicle.

Moreover, although an example has been described in the above exemplary embodiments in which the carwash device 13 determines the vehicle states based on the vehicle state information, and outputs an instruction signal to the vehicle control section 142 instructing to prepare the specific components of the vehicle 12 for car-washing in cases in which the vehicle state information does not satisfy the predetermined conditions, there is no limitation thereto. For example, the control section 132 of the carwash device 13 may output a request signal to the vehicle control device 14 requesting to start car-washing of the vehicle, and the vehicle control device 14 may change the states of the specific components included in the vehicle 12 in response to the received request signal. Thus, the car-washing target vehicle 12 itself changes the states of the specific components without going through the processing to determine whether or not the vehicle state information satisfies the predetermined conditions. For example, in cases in which the vehicle door mirrors are not retracted, the door mirrors of the vehicle 12 may be retracted in response to the received request signal, such that the vehicle 12 is set to a suitable state for car-washing.

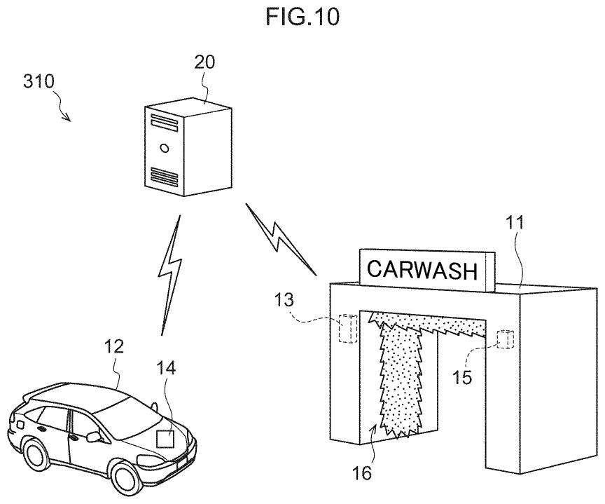

Moreover, although an example has been described in the above exemplary embodiments in which information is directly exchanged between the vehicle control device 14 and the carwash device 13, there is no limitation thereto. For example, a configuration such as that illustrated in FIG. 10 may be applied. In such cases, as illustrated in FIG. 10, a car-washing system 310 may include an external server 20, and information may be exchanged between the vehicle control device 14 and the carwash device 13 via the external server 20. Moreover, some or all of the functionality of the carwash device 13 or the vehicle control device 14 may be implemented by the external server 20.

Moreover, although an example has been described in which the vehicle control device 14 of the above exemplary embodiments controls so as to change the states of the specific components of the vehicle 12 so as to prepare the specific components for car-washing in cases in which the vehicle state information does not satisfy the predetermined conditions, there is no limitation thereto. For example, the vehicle control device 14 may notify a user of the fact that the vehicle state information does not satisfy the predetermined conditions. For example, the vehicle control device 14 may include functionality to notify that the vehicle state information does not satisfy the predetermined conditions using a vehicle interior monitor or a warning sound. In such cases, the vehicle control device 14 may control so as to display information indicating that the vehicle state information does not satisfy the predetermined conditions on a display section (not illustrated in the drawings) inside the vehicle 12. Alternatively, the vehicle control device 14 may control so as to output a warning sound indicating that the vehicle state information does not satisfy the predetermined conditions through an audio output device (such as a speaker; not illustrated in the drawings) inside the vehicle 12. This enables the user to realize that the vehicle 12 is in an unsuitable state for car-washing, and to take appropriate action such as closing the doors.

All publications, patent applications, and technical standards mentioned in this specification are herein incorporated by reference to the same extent as if each individual publication, patent application, or technical standard was specifically and individually indicated to be incorporated by reference.

1. A carwash device comprising a memory and a processor coupled to the memory, the processor being configured to:
receive vehicle state information transmitted from a vehicle control device of a vehicle; and
control so as to drive a drive section for washing the vehicle based on the received vehicle state information.

2. The carwash device of claim 1, wherein:
the vehicle state information includes at least one type of information selected from the group consisting of a deployed/retracted state of a door mirror, an open/closed state of a window, an open/closed state of a door, an open/closed state of a fuel filler port, and an ignition state indicating a state of an ignition; and
the processor controls the drive section so as to wash the vehicle in a case in which the vehicle state information satisfies a predetermined condition.

3. The carwash device of claim 1, wherein:
the processor is configured to output a request signal to the vehicle control device requesting to start car-washing of the vehicle;
the vehicle control device is configured to output the vehicle state information to the carwash device in response to the request signal;
the processor outputs an instruction signal to the vehicle control device instructing to change a state of a specific component included in the vehicle in a case in which the vehicle state information does not satisfy a predetermined condition; and
the vehicle control device is configured to either control so as to change the state of the specific component included in the vehicle in response to the instruction signal, control so as to display information indicating that the vehicle state information does not satisfy the predetermined condition on a display section inside the vehicle, or control so as to output a warning sound indicating that the vehicle state information does not satisfy the predetermined condition through an audio output device inside the vehicle.

4. The carwash device of claim 1, wherein:
the processor is configured to output a request signal to the vehicle control device requesting to start car-washing of the vehicle; and
the vehicle control device is configured to control so as to change a state of a specific component included in the vehicle in response to the received request signal.

5. The carwash device of claim 1, wherein:
the processor is configured to select a car-washing mode based on the vehicle state information; and
the processor is configured to control the drive section so as to wash the vehicle in the selected car-washing mode.

6. The carwash device of claim 1, wherein the processor is configured to:
additionally receive vehicle type information indicating a type of the vehicle;
select a car-washing mode based on the vehicle state information and the vehicle type information; and
control so as to drive the drive section according to the selected car-washing mode.

7. The carwash device of claim 1, wherein the processor is configured to:
additionally receive travel history information indicating a travel history of the vehicle;
select a car-washing mode based on the vehicle state information and the travel history information; and
control so as to drive the drive section according to the selected car-washing mode.

8. A car-washing system comprising:
the carwash device of claim 1; and
a vehicle control device.

9. A car-washing method in which a processor executes processing comprising:
receiving vehicle state information transmitted from a vehicle control device of a vehicle; and
controlling so as to drive a drive section for washing the vehicle based on the received vehicle state information.

10. A non-transitory recording medium storing a car-washing program that is executable by a computer to perform a process comprising:
receiving vehicle state information transmitted from a vehicle control device of a vehicle; and
controlling so as to drive a drive section for washing the vehicle based on the received vehicle state information.
